(19) United States
(12) Patent Application Publication
(10) Pub. No.: US 2005/0082473 A1
(43) Pub. Date: Apr. 21, 2005

(54) Mobile system for in situ acquisition of carbon isotope data on natural gas

(75) Inventors: Richard A. Socki, Houston, TX (US); Kadry K. Bissada, Bellaire, TX (US)

Correspondence Address: Robert C. Shaddox;Winstead Sechrest & Minick P.C., P.O. Box 50784, Dallas, TX, 75201, US

(73) Assignee: In Situ Isotope Services, Inc., Houston, TX (US)

(21) Appl. No.: 10/917,609

(22) Filed: Aug. 13, 2004

Related U.S. Application Data
(60) Provisional application No. 60/495,434, filed on Aug. 15, 2003.

(51) Int. Cl. H01J 49/00

(52) U.S. Cl. 250/288

(57) ABSTRACT

The present invention relates to a mobile analytical system to make stable carbon isotope measurements of both bulk hydrocarbon and individual hydrocarbon compounds in natural gas at the exploration and production well site.

### FIELD OF THE INVENTION

The present invention relates to a mobile system for in situ acquisition of carbon isotope data on both bulk hydrocarbon mixtures and individual components in natural gas during oil and gas exploration and production.

### BACKGROUND OF THE INVENTION

Recent economics of the oil and gas industry have placed more stringent requirements on improving efficiency and effectiveness of both exploration and production projects. Furthermore, as conventional hydrocarbon reserves become more difficult to find and extract and as dependence on basin-center gas, deep tight-sand reservoirs and coal-bed gas increases, new technologies to explore them and produce them become more crucial. Explorationists need not only the means to assess adequacy of hydrocarbon supply and effectiveness of migration routes to identified prospects, but also the means for detection and characterization of the hydrocarbons in the pay zones while drilling. Development and production geologists/engineers concerned with reservoir performance issues are seeking better means for mapping pathways and barriers to fluid flow within a reservoir system and for zonal production allocation in co-mingled production streams. Over the last decade, new techniques in petroleum geochemistry have contributed significantly to meeting these needs, particularly in crude oil exploration and production projects where hundreds of bio-geochemical markers have been used for characterization, fingerprinting and correlation (Bissada, et al., 1993; Peters and Moldowan, 1993; Chen, et al., 1997). Applications in natural gas exploration and production projects are less prominent because diagnostic chemical markers are limited to one to a maximum of seven compounds. Nevertheless, several successful applications have been documented (Quinones, et al., 2001; Bissada, et al., 2002; Schoell, et al., 1993; Rice, 1993; Faber, et al., 1992; and Ellis, et al., 1999). This was possible by the introduction of the powerful GC-C-IRMS technology (tandem Gas Chromatography-Combustion-Isotope Ratio Mass Spectrometry) for compound-specific carbon isotope analysis of natural gas.

In spite of these successes, application of this technology to its fullest extent both in conventional natural-gas exploration and production projects and in basin-center gas, deep tight-reservoir gas and coal-bed gas development projects has been limited by four major impediments:
1. The length of time between sample acquisition and data analysis. It is not uncommon for the project geologist/engineer to wait several weeks to receive isotope data (a process that includes field sampling, shipping of the sample from the field location to the laboratory, sample extraction, sample analysis, and, finally, data interpretation).
2. The high cost and safety concerns associated with shipping high-pressure gas cylinders.
3. The leakage and complete loss of gas samples from low pressure, “safe” sampling containers (Vacutainers® and gas-bags) during shipping. This often necessitates re-sampling and re-shipping with associated additional costs and project delays.
4. The partial leakage of sample during shipping has been shown to result in isotopic fractionation and alteration of the isotopic chemistry of the sample (Caballero, et al., 2000), thereby jeopardizing the interpretation and the significance of the results.

Most of the problems that stand in the way of wide application of this powerful technology could be eliminated if the analyses were to be conducted in situ within the field setting. However, the sheer size, weight and fragility of lab-based GC-C-IRMS equipment prohibit their use within a field setting. Applicants have developed and plan to deploy a compact, more rugged, mobile GC-C-IRMS system weighing generally no more than about 75 kg and being easily transportable by small truck or sport utility vehicle. This system is designed to streamline the isotope data-acquisition process by doing all analytical and interpretive steps in the field, essentially bringing the entire stable isotope geochemical lab to the well site. It entails innovative technology that interfaces a significantly scaled-down isotope-ratio mass spectrometer with a micro-Gas Chromatograph (micro-GC), a more rugged and efficient combustion/dehydration module, and improved data processing software to achieve a fully mobile, integrated analysis and processing system.

### SUMMARY OF THE INVENTION

The present invention relates to a two-channel gas chromatograph-combustion-isotope mass spectrometer system that would allow monitoring at very high frequencies the isotopic signature of the THG (Total Hydrocarbon Gas) in the degassing mud stream on one of two channels (i.e., no separation, total C isotope analysis), while collecting compound-specific isotope data on the critical hydrocarbon “shows” on the second channel.

### BRIEF DESCRIPTION OF THE DRAWINGS

FIG. 1. The hydrocarbon gases extracted from the drilling mud stream or from a well-head source are stripped of moisture (using a Nafion® membrane or other dehydrating agent) and of any contained H₂S (using silver gauze or other H₂S-scavenging agent). The “clean” stream is then directed towards a sample-splitter where a portion of the Total Hydrocarbon Gas mixture (THG) is directed into Channel 1 (THG/C/IRMS) of the system that constitutes a Combustion Furnace and a separate Water Scrubber and on to the Isotope Ratio Mass Spectrometer for measuring the carbon isotopic composition of the CO₂ representing the carbon in the total gas mixture. The second portion of the split gas stream is directed towards the second channel in the system where a sampling and injection module allows multiple aliquots of the gas mixture to be stored in multiple sample loops on a multi-position Valco® valve unit until ready for sequential injection into the GC/C/IRMS. In this channel the hydrocarbon gas components are separated using a Poroplot Q® or other suitable GC column at isothermal or programmed temperature (e.g. from 50° C. to 210° C.). The column effluent is then fed directly into a pre-oxidized Cu—Ni—Pt combustion reactor or other suitable catalytic reactor that converts the hydrocarbons to carbon dioxide and water. Water is removed by a Nafion® membrane tube prior to entry into a scaled-down isotope ratio mass spectrometer. The invention includes its own proprietary software tailored for use in the invention portable GC/C/IRMS, called ISISware©. The software has all the data reduction capabilities of conventional GC-C-IRMS used in the highest precision lab-based instruments and has capability to curve-fit and to tailor outputs to the specific application of light hydrocarbon analysis. Background corrections in both the independent and dynamic methods have been implemented (reproducibility of raw data (δ¹³C) about SD <0.3).

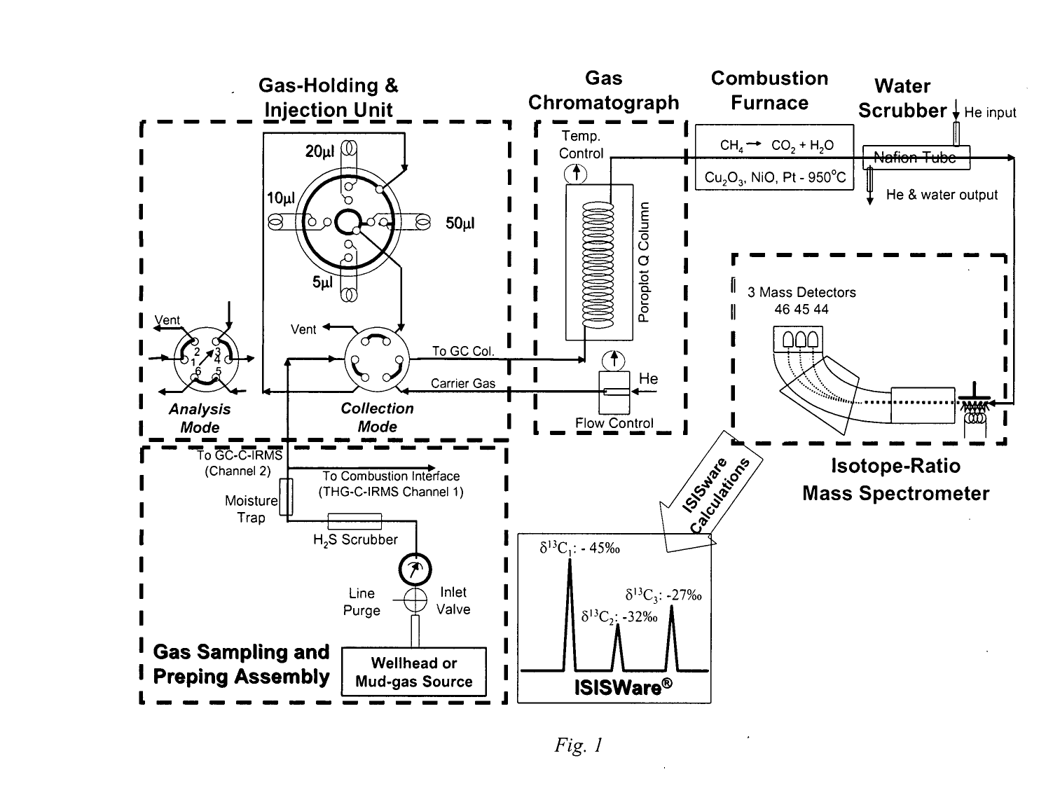

FIG. 2. Isothermal GC column housing. This drawing shows the overall dimensions of the aluminum housing that holds the GC column, insulation, heaters, and thermocouple probe. The housing measures 88.5 mm in diameter and consists of a base and lid that when attached are 21.6 mm high. The housing is held together by three equally spaced stainless steel screws tapped into the base. Grooves machined in the side of the base allow for heater wires and thermocouple wires to pass through the housing.

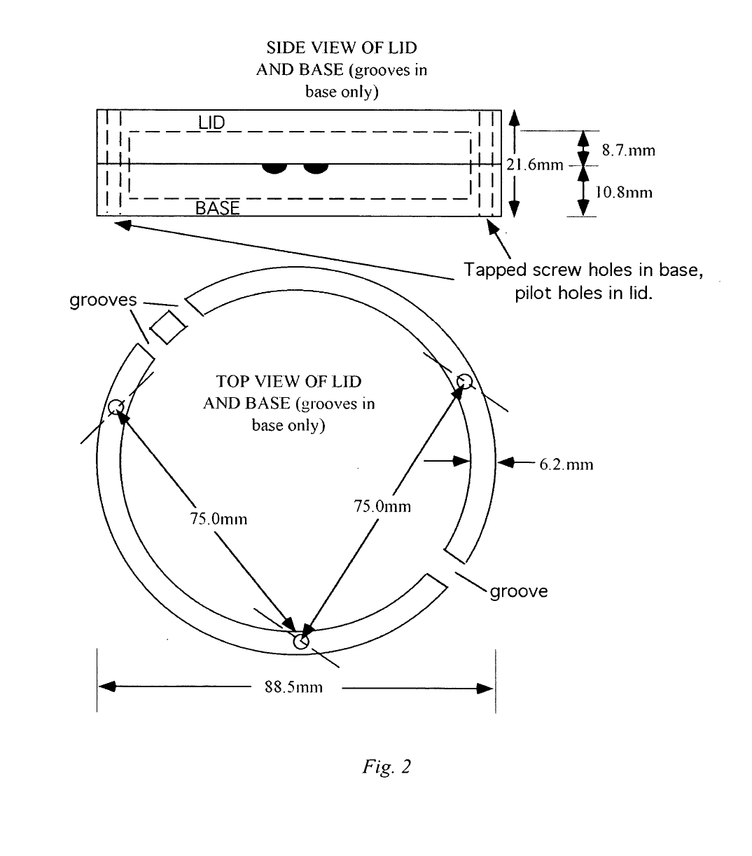

FIG. 3. Expanded view of Isothermal GC Column housing showing all components. Within the housing are the following (from top to bottom): 1. insulation layer; 2. a single 3″ diameter flexible silicone rubber heater disc (Omegalux®, model SRFR-3/5, Omega Engineering, Stamford, Conn.); 3. a 10 meter long Poraplot Q® GC column with a type “K” thermocouple probe intimately attached to the column with a small piece of thermal tape; 4. a single 3″ diameter flexible silicone rubber heater disc (Omegalux®, model SRFR-3/5; 5. insulation layer.

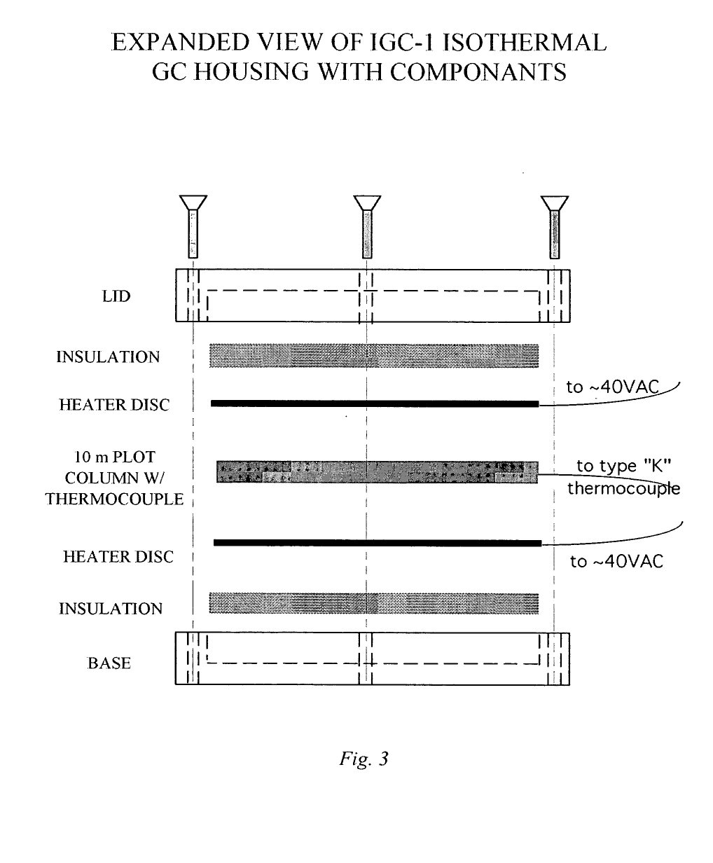

### DETAILED DESCRIPTION OF THE INVENTION

The present invention is a portable and robust field-deployable Combustion-Isotope Ratio Mass Spectrometer (C/IRMS) system that includes two parallel channels, one that allows monitoring at very high frequencies the isotopic signature of the Total Hydrocarbon Gas (THG) in the degassing mud stream (i.e., no separation, total C isotope analysis) via a Combustion-Dehydration-IRMS measurement assembly, and the other that allows collecting compound-specific isotope data on the critical hydrocarbon “shows” via a multi-sample holding and injection module connected to a GC/C/Isotope Ratio Mass Spectrometer assembly. The front ends of both channels send hydrocarbons (either the “raw” hydrocarbon gas mixture or the individual hydrocarbon compounds) into a combustion interface to combust hydrocarbons (including methane) quantitatively. The combustion products (CO₂ and H₂O) pass into an apparatus to remove water. The dry CO₂ is automatically injected into the IRMS. It also has the capability for injecting an isotopically-calibrated standard gas. The combustion furnace is rated to hold temperatures of 1200° C. and can easily accommodate the 950° C. required to efficiently combust methane. The furnace is portable and easily serviced (re-oxidized) using a bottled or compressor-supplied air. The reference gas (CO₂) is injected from an external gas lecture bottle and is incorporated in the front end of the GC. The invention uses an Isothermal Gas Chromatograph (IGC) that consists of a coiled 10 meter Poraplot Q® column housed in an aluminum chamber ˜3.5″ in diameter. The column is heated using two 3″ diameter flexible silicone rubber heater discs (Omegalux®, model SRFR-3/5, Omega Engineering, Stamford, Conn.) and is held at 105° C. with the temperature measured and controlled with a thermocouple-equipped temperature controller.

The interface resides in a portable housing case measuring ˜10″×8″×8″. This is connected to the mass spectrometer via stainless steel capillary tubing. The mass spectrometer is ˜13″×22″×28″. The instrument is lightweight (total weight is ˜75 kg) and robust. Capillary plumbing from the gas supply to the GC injector is constructed from lightweight, robust chromatography-grade PEEK polymer capillary tubing available from Valco Instruments (Houston, Tex.). This capillary will carry He and air only. Capillaries from the injector to the water trap are chromatography-grade stainless steel or other suitable metal to provide for robust sample transfer suitable compatible with capillary chromatograph to avoid tailing/peak distortion or isotopic fractionation. Tubing from the water trap to the open split and into the IRMS is also PEEK.

The furnace uses one of two different style reactors. In one incarnation, the furnace is a custom-built ceramic of inside diameter 0.020 inch and outside diameter at least 0.125 inch. The large outside diameter imparts structural stability to the reactor. In another incarnation, the reactor is a superalloy (e.g., Hastelloy©) or other suitable metal, compatible with 950° C. This embodiment also imparts structural stability of a metal in a lightweight, compact design. Connections from metal capillaries are made to both furnaces by means of high temperature epoxy or permanent bonding using proprietary brazing techniques available in the marketplace.

The invention also includes its own proprietary software, called ISISware©, tailored for use in the conceived “portable” Dual Channel THG/C/IRMS-GC/C/IRMS (Dual Channel Total Hydrocarbon Gas/Combustion/Isotope Ratio Mass Spectrometer—Gas Chromatography/Combustion/Isotope Ratio Mass Spectrometer system). The software has all the data reduction capabilities required in high-precision GC/C/IRMS instruments and has capability to curve-fit and to tailor outputs to the specific application of light hydrocarbon analysis. Background corrections in both the independent and dynamic methods is built-in to ensure reproducibility of raw data about SD (δ¹³C) <0.3.

The software is optimized for automated analysis of chromatograms of natural gas. In a parameter routine, the user selects regions where standard pulses are to be found, as shown in the EXAMPLE figure, where the user selects which hydrocarbon components will be analyzed, and the approximate location by means of cursors. Once defined, the software will search series of chromatograms for peaks, integrate them as requested by the user, and present them in graphical and spreadsheet form.

It is routine practice in laboratory-based hydrocarbon analysis to run multiple injections of the same gas sample in order to match the signal intensities of individual components and the standard CO₂ pulse. This is because most gas samples are predominantly methane, with variable amounts of other hydrocarbons and of CO₂. One of the major reasons that small peaks are not well calibrated by substantially larger CO₂ pulses is because of differences in establishing the background CO₂ levels and consistently subtracting them, a property inherent to the summation algorithm. In theory, curve fitting does not suffer this drawback. Using curve-fitting routines that are incorporated into ISISware©, allows for hydrocarbon analysis in the range over which peaks can be isotopically calibrated. This approach reduces the number of injections required to analyze specific samples where methane concentrations are extremely high and the other components are very small (“dry gas”). This capability offers definite advantages over laboratory-based systems in that it allows for a much wider dynamic range for data processing. Furthermore, the software is designed to facilitate data “migration” and “stacking” for multiple injections of gas aliquots of varying sizes for the same sample at a given shot-point. This allows merging of multiple records into a single set that describes the isotopic attributes of all the components at the given “shot-point. This is particularly important when using the multi-loop “aliquot parking” and sequential runs principle in channel 2 where the software would routinely merge multi-data runs for the same shot-point.

[image]

1. A mobile and robust field-deployable combustion-isotope ratio mass spectrometer that permits in situ analyses.

2. A method of determining isotopic data on gaseous mixtures and individual compounds using the mass spectrometer of claim 1.

3. The method of claim 2, wherein the acquired data is transmitted from the measurement location to a different location via a telecommunication network, allowing an analysis of the data to be carried out remotely.

4. A mobile, dual-channel combustion-isotope ratio mass spectrometer comprising:
a) a first channel that allows monitoring at very high sampling and analysis frequencies the isotopic signature of the Total Hydrocarbon Gas (THG) in the degassing mud stream via a Combustion-Dehydration-IRMS measurement assembly; and
b) a second channel that allows collecting compound-specific isotope data on the critical hydrocarbon “shows” via a multi-sample holding and injection module connected to a GC/C/Isotope Ratio Mass Spectrometer assembly.

5. The dual-channel combustion-isotope ratio mass spectrometer of claim 4, wherein the front ends of both channels send hydrocarbons into a combustion interface to combust hydrocarbons quantitatively.

6. A method of determining isotopic data on gaseous mixtures and individual compounds using the mass spectrometer of claim 4 comprising the steps of:
a) combusting the hydrocarbons of interest;
b) passing the combustion products (CO2 and H2O) into an apparatus to remove water; and
c) injecting the CO₂ automatically into the IRMS for analysis.
